(19) United States
(12) Patent Application Publication
(10) Pub. No.: US 2024/0028950 A1
(43) Pub. Date: Jan. 25, 2024

(54) METHOD AND SYSTEM FOR URBAN ROAD INFRASTRUCTURE MONITORING

(71) Applicant: Conduent Business Services, LLC, Florham Park, NJ (US)

(72) Inventors: Saikat Saha, Bangalore (IN); Piyush Vinod Raikwar, Amravati (IN); Neeraj Gudipati, Safilguda (IN); Arun Koushik Parthasarathy, Bangalore (IN)

(21) Appl. No.: 17/870,311

(22) Filed: Jul. 21, 2022

(51) Int. Cl. G06N 20/00; G06N 5/04

(52) U.S. Cl. CPC G06N 20/00; G06N 5/04

(57) ABSTRACT

Methods and systems for monitoring infrastructure, can involve capturing video of infrastructure, and generating an inference of damage to the infrastructure and a severity thereof based on images in the captured video and in response to running the inference locally on one or more edge devices. The running of the inference can take place locally on the edge device(s) using a compression of models to run the inference on the at edge device(s) with a low computational resource. Privacy preserved learning can be enabled when generating the inference and the severity thereof by using distributed data subject to federated learning frameworks.

### TECHNICAL FIELD

Embodiments are related to the monitoring of urban infrastructure including roads and other features. Embodiments further relate to the classification and assessment of infrastructure damage. Embodiments also relate to the use of edge devices for infrastructure monitoring.

### BACKGROUND

A Smart City is an urban area that uses different types of electronic data collection sensors to supply information which is used to manage assets and resources efficiently. A goal of the Smart City is to gather information to enhance decision making. Further, by integrating rural and urban economies, a Smart Region can be created. There is a need for improved systems, methods, and architectures to enhance decision making in these areas.

The concept of the Smart City with a focus on improved urban living conditions, has recently gained a great deal of attention from governments, urban planners, researchers, and so on. A key component of the Smart City concept is infrastructure and in particular, road infrastructure, which can provide a network of roads that can ensure the sustainable and safe movement of people, goods, and services. Naturally, there is a growing interest about how we can better manage this road infrastructure (e.g., road surface conditions, streetlights, road signals, curbside usage, etc.).

Damaged roads remains one of the most common causes of road accidents and is an impediment towards any progress to different safety initiatives. Not only are severely damaged roads of concern, but roads having the occasional crack or pothole is also of concern, particularly where a driver may lose control of a vehicle over such infrastructure damage. In addition, damaged roads can lead to congestion, slowing the movement of traffic, which in turn can reduce the productive hours (i.e., quality of life) of a road's users. Damaged roads also act as an obstacle to emergency services.

Traditionally, keeping track of road damages and determining which parts of the roads needing attention has been done manually through on-site inspection. This is inefficient as well as labor intensive, as it requires a manual survey to identify, cross-reference, and log this information. Because of this, surveying an entire infrastructure road network can become a huge financial burden for a municipality authority. Automating this process can result in an efficient, less time-consuming approach and greatly assist in the efficient maintenance of, for example, existing roads. However, any automated road assessment should be cost effective, scalable and not dependent upon very expensive equipment (e.g., LIDAR).

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, an aspect of the embodiments to provide for methods and systems for the classification of infrastructure damage and the assessment of the severity of the damage.

It is another aspect of the embodiments to provide for a system framework that can run an inference of the infrastructure damage locally on one or more edge devices.

It is a further aspect of the embodiments to provide for a compression of models to run on one or more edge devices with low computational resources.

It is also an aspect of the embodiments to provide for a system framework and methods thereof, which can enable privacy preserved learning from distributed data using various federated learning architectures.

The aforementioned aspects and other objectives and advantages can now be achieved as described herein. In an embodiment, a method of monitoring infrastructure, can involve capturing video of infrastructure, and generating an inference of damage to the infrastructure and a severity thereof based on images in the captured video and in response to running the inference locally on at least one edge device.

In an embodiment, the running of the inference can take place locally on the at least one edge device using a compression of models to run the inference on the at least one edge device with a low computational resource.

In an embodiment, privacy preserved learning can be enabled when generating the inference and the severity thereof by using distributed data subject to at least one federated learning framework.

In an embodiment, the at least one edge device can include or may be associated with a camera mounted on at least one vehicle of a public transportation fleet of vehicles.

In an embodiment, the location of the damage to the infrastructure can be based on the position of the at least one vehicle.

An embodiment can involve displaying data indicative of the inference of damage to the infrastructure in a cartographic display.

The disclosed embodiments can be implemented to classify infrastructure damage and assess the severity of this damage based on the input video feed of the infrastructure sections, captured through mounted cameras with the edge devices on the vehicles that are typically part of a public transportation fleet. The embodiments can involve the capture of the location of the damage to the infrastructure based on, for example, vehicle positions (e.g., using GPS).

Infrastructure damage information can be visually presented in a cartographic display for further downstream consumptions. As there may be restrictions of sharing the raw videos (e.g., to a central server) due to privacy regulations, a system framework can be provided, which can run the inference locally in the edge devices.

Lighter compressed models can be run on the edge devices with low computational resources. Moreover, a framework can be implemented, which can incorporate different types of Federated Learning, which can enable learning from distributed data, typically without a compromise on the data privacy. Architectures for different scenarios (e.g., computational resources and data privacy requirements) can also be implemented in accordance with varying embodiments.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the principles of the embodiments.

FIG. 1 illustrates an image of a feature comprising a crack on a surface, in accordance with an embodiment;

FIG. 2 illustrates an image of a feature comprising a pothole, in accordance with an embodiment;

FIG. 3(a) illustrates a schematic diagram of a network that has been pruned unstructured, in accordance with an embodiment;

FIG. 3(b) illustrates a schematic diagram of a network subject to structured pruning with fade connections/nodes representing removed/pruned values in the network, in accordance with an embodiment;

FIG. 4 illustrates a flow diagram depicting logical operational steps of a filter pruning operation, in accordance with an embodiment;

FIG. 5 illustrates a schematic diagram of a federated learning framework, which can be implemented in accordance with an embodiment;

FIG. 6 illustrates a schematic diagram of a split learning framework, in accordance with an embodiment;

FIG. 7 illustrates a schematic diagram of a split-federated learning framework, in accordance with an embodiment;

FIG. 8 illustrates a block diagram of a system for infrastructure monitoring, in accordance with an embodiment;

FIG. 9 illustrates an example graph depicting data indicative of centralized learning versus federated learning, in accordance with an embodiment;

FIG. 10 illustrates an example graph depicting data indicative of a client model versus a global model, in accordance with an embodiment;

FIG. 11 illustrates an example graph depicting data indicative of training on open-source and then private data, in accordance with an embodiment;

FIG. 12 illustrates an example graph depicting data of varying sparsity, in accordance with an embodiment;

FIG. 13 illustrates a schematic view of a data-processing system, in accordance with an embodiment; and

FIG. 14 illustrates a schematic view of a software system including a module, an operating system, and a user interface, in accordance with an embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

After reading this description it will become apparent how to implement the embodiments described in various alternative implementations. Further, although various embodiments are described herein, it is understood that these embodiments are presented by way of example only, and not limitation. As such, this detailed description of various alternative embodiments should not be construed to limit the scope or breadth of the appended claims.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. In addition, terms or phrases such as “at least one” may refer to “one or more”. For example, “at least one widget” may refer to “one or more widgets”.

Several aspects of data-processing systems will now be presented with reference to various systems and methods. These systems and methods will be described in the following detailed description and illustrated in the accompanying drawings by various blocks, modules, components, circuits, steps, processes, algorithms, etc. (collectively can be referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A mobile “app” is an example of such software.

An example of a data processing system or device is a server. The term ‘server’ as utilized herein can relate to a software or hardware device that can accept and respond to requests made over a network. The device that makes the request, and receives a response from the server, is called a client. On the Internet, the term “server” commonly refers to the computer system that receives requests for a web files and sends those files to the client.

The term ‘image’ as utilized herein relates to a digital image, which is an image composed of picture elements, also known as pixels, each with finite, discrete quantities of numeric representation for its intensity or gray level that is an output from its two-dimensional functions fed as input by its spatial coordinates denoted with x, y on the x-axis and y-axis, respectively.

The term ‘user interface’ as utilized herein relates to the point of human-computer interaction and communication in a device. A user interface (UI) can include display screens, keyboards, a mouse and the appearance of a desktop. The UI is also the way through which a user can interact with an application or a website. An example of a UI is a graphical user interface (GUI).

Note that the term ‘infrastructure’ as utilized herein can relate to the underlying structure of a country, region, municipality, and its economy, including but not limited to fixed installations including roads, bridges, dams, water and sewer system, railways, subways, airports, harbors, and the like.

The embodiments relate to simple and effective artificial intelligence (AI) based infrastructure damage methods, systems, and devices. Noting that a public vehicle fleet covering a transportation network can be exploited inexpensively and passively (i.e. without manual interventions) to take streams of video of the roads (possibly with other sensor reading, e.g., accelerometer, gyroscope) while the vehicles make their journeys, the disclosed embodiments propose to monitor these road conditions primarily with a computer vision application (note that the disclosed approach is not limited only to public transportation fleet, but is broad enough and sufficiently applicable to heterogeneous fleet systems including, for example, public and privately owned vehicles).

Given a stream of video input, using the disclosed AI models, we can detect and classify different road damage into four predefined classes—horizontal crack, vertical crack, alligator crack, and pothole. Furthermore, we can assess the severity of road damage for different damage classes (acceptable, poor and severe). Once the damage inference can be obtained and if the GPS location stamps are available, inferred road damages can be displayed in a cartographic (map based) front-end display for end users.

Note that the term ‘model’ as utilized herein relates to AI models including constructing machines that can simulate human intelligence. An AI model is a program or algorithm that can utilize a set of data that can enable it to recognize certain patterns. This allows it to reach a conclusion or make a prediction when provided with sufficient information.

A primary advantage of the embodiments can involve the enablement of early detection/warning regarding road damage, so rather than reactive, preventive maintenance can be accomplished. An advantage of this approach can also involve enabling prioritization of road segments requiring damage repairment, which in turn helps in planning and allocating budgets for municipality authorities. A further advantage of the embodiments stems from the provision of analytical insights regarding spatio-temporal aspects of the infrastructure damage.

In terms of overall solutions, there are two principal challenges. First, less data for a given environment may be available, to start with at the beginning. This is problematic especially for any deep neural network (DNN) based approach, which is data hungry, and can create a learning challenge. Second, video stream captured through a camera associated with each vehicle, for example, might be subject to privacy regulations. So, rather than sending data to a central server or ‘cloud’ for any training or inference purpose, we can move the model to the data captured by individual vehicle. However, computational resources available locally (i.e., an edge device available in a bus) might be restricted, so we need to make those models light (in terms of computation and memory use). Rather than addressing a very specific solution, we can consider here a suite of solutions that may be relevant depending on the status of the above two constraints. These details are described in the next sections.

Note that the term ‘edge device’ as utilized herein can relate to a device or apparatus that can provide an entry point into, for example, enterprise or service provider core networks. Examples includes routers, routing switches, integrated access devices (IADs), multiplexers, and a variety of metropolitan area network (MAN) and wide area network (WAN) access devices. Edge devices also can provide connections into carrier and service provider networks. Another example of an edge device may be a smartphone or mobile computing device equipped with or associated with a digital camera or a group of digital cameras. Other examples of edge devices include computing boards such as, for example, Raspberry Pi and the Jetson Nano. Note that the term ‘camera’ as utilized herein is an example of an image-capturing device that may be used in accordance with an embodiment. That is, it should be appreciated that other type of image-capturing devices may be implemented in accordance with varying embodiments.

Given an input video of a road, for example, our aim is to identify all road damage, classify the damage according to their pre-defined categories, and then assess the severity of each item or feature subject to damage. Our approach has a hierarchical setting—first we can classify each damage according to one of the following categories: horizontal crack, vertical crack, alligator crack, and pothole. Then, for each predicted category, we can predict the severity as one of the following: acceptable, poor and severe.

In doing so, we can build a model and our task is twofold—train the model (learning) and whenever we obtain a new video of a road segment, we can use the trained model to predict the damage (inference). We first outline a baseline approach, which can include two pipelines: (a) damage detection, classification and tracking; and (b) assessment of damage severity.

We can perform object detection and classification using, for example, Ultralytics YOLOv5. YOLO (You only look once) is a family of popular single-shot detection algorithms for performing real-time object detection. This means that it can detect and classify objects in ‘one shot’ only and does so in a fast and efficient manner. We can use YOLOv5, which is the latest addition to the YOLO approach. The following are some reasons that we may consider YOLOv5 over alternatives (e.g., MobileNet-SSD. First, YOLO can perform better when small objects are involved. In a road defect scenario, for example, there is a good chance that YOLO will perform better. Furthermore, we can use an open source codebase (e.g., from the topper of a GRDD competition) available to us with pre-trained damage classification model. In addition, there are very few resources for performing structured pruning on YOLO compared to MobileNet-SSD, leaving us scope for exploration.

In YOLO, an image can be divided into a S×S grid and each cell is responsible for detecting objects whose center falls inside that grid. After performing a forward pass, we will have, for example, a 9×S×S×N tensor, where N is the number of anchor boxes. The number 9 above comes from, if the object is predicted (i.e., 1 value), bounding box dimensions (4 values), and 4 for number of classes. That is S×S×N predictions, out of which some predictions are later discarded based on their confidence scores. After this, predictions having intersection over union (IoU) as a metric, higher than some threshold, can be discarded. The remaining predictions are the final predictions.

We can also introduce object tracking (i.e., tracking individual detected damage) to keep track of road defects that are appearing more than once in successive frames. Ideally, we want to log each damage only once. Object tracking helps in identifying previously appeared damages, thus assisting in reducing redundancy. Furthermore, object tracking helps in dealing with situations such as the varying speed of the vehicle, on which a camera may be mounted. Moreover, tracking removes any restriction on sampling images at a specific frame rate. For object tracking, we can use a Kalman filter based SORT (Simple and online real-time tracking) method. One advantage of SORT is that even if the detection method fails to identify the object in the current frame, SORT can maintain the track if the object is detected in any of the immediate past n frames, where n is a predetermined number. Thus, SORT can predict the location of the object even if the detection is missing.

We can use SORT compared to more advanced algorithms such as, for example, DeepSORT due to the following reasons. DeepSORT needs an additional deep neural network to run for extracting visual features. Thus, this makes object tracking computationally more expensive, so it is not favorable to our case. The visual features are beneficial for cases where an object's identity is difficult to maintain (e.g., when object tracks cross each other). However, in our case, road defects will appear to move from top to bottom in subsequent frames and there will not be an intersection of tracks.

Since the class labels are corresponding to what type of damage is present and not how severe the damage may be, we may have to assess the severity based on other parameters. The embodiments involve the use of the dimensions of the detected bounding box as a proxy for the actual dimensions of the defect. Since the line of sight of the camera will be at a specific angle, which will not be perpendicular to the road, there will be some error due to shear. In order to reduce this error, we can consider the bounding box of each damage, when it is closest to the vehicle (i.e., that the particular damage is last observed).

After we obtain our bounding box dimensions for each damage, we can calculate the area of the bounding box as a feature for determining the severity of alligator crack and pothole and the diagonal of the bounding box as a feature for both vertical and horizontal cracks. Area is most logical for pothole and alligator crack, and the length of the diagonal is logical because most cracks that are detected appear to go from one corner to another diagonally opposite corner. Even if the cracks are purely vertical or horizontal, length or breadth will be close to zero, thus making the diagonal approximately equal to the remaining side.

Finally, once those features (diagonal or area) are obtained, based on domain knowledge, we can set thresholds to determine the severity category. However, in the absence of domain knowledge, we can use K-means clustering to cluster features into three categories i.e., acceptable, poor and severe. We can make use of separate clustering models for each kind of damage, i.e., cracks, pothole, and alligator crack. Thus, we can use three models for clustering after combining vertical and horizontal crack into a single group.

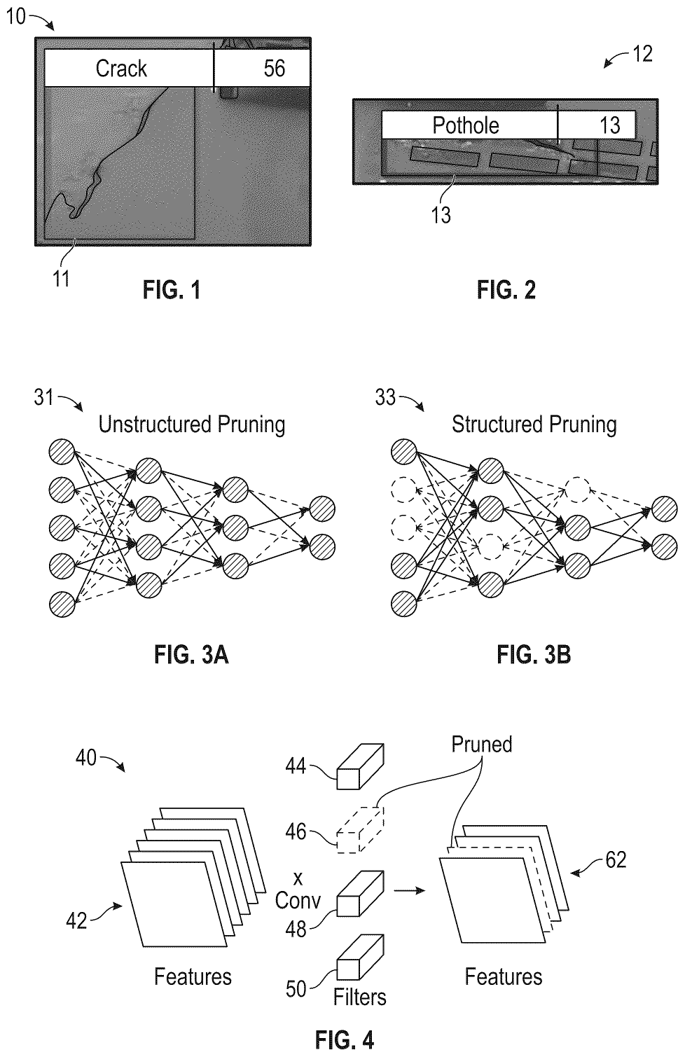

Note that FIG. 1 illustrates an image 10 of a feature comprising a crack on a surface, in accordance with an embodiment. In the example image 10 shown in FIG. 1, the text “Crack|56” is displayed, with the word “Crack” shown above a graphically displayed box 11 interposed on the image 10. FIG. 2 illustrates an example image 12 of a feature comprising a pothole, in accordance with an embodiment. In image 12, the text “Pothole|13” is displayed with the word “Pothole” displayed at the top of the graphically displayed box 13.

Now suppose that we have a baseline model, which can be trained on publicly available data. However, as noted earlier, the vehicles are typically fitted with cameras mounted on suitable edge devices (e.g., Raspberry Pi, Jetson Nano) with limited memory and/or computational resources. As the videos of roads captured through cameras might be subject to privacy regulations, video data cannot be sent to any central server or cloud. Consequently, we may need to run the base model in the local edge device for the inference. The environment constraints on the local edge devices thus may require that the model should be light enough to run there. Thus, we may create a light weight (compressed) model generated from the baseline model and which can be also trained on publicly available data. Next, we describe on the model compression part.

FIG. 3(a) illustrates a schematic diagram of a network 31 that has been pruned unstructured, in accordance with an embodiment. FIG. 3(b) illustrates a schematic diagram of a network 33 subject to structured pruning with fade connections/nodes representing removed/pruned values in the network, in accordance with an embodiment.

Model compression is about making the deep neural network model lighter and computationally more efficient. This can be generally accomplished by pruning (i.e., removing unnecessary components in a neural network that does not necessarily contribute much towards predicting the final outcome). Depending on the components removed, there are two types of pruning—unstructured pruning as shown in FIG. 3(a), and structured pruning as depicted in FIG. 3(b).

In unstructured pruning individual weights/connections can be removed, thus offering more flexibility/freedom to the process and so retains higher performance. But the downside is that, since it results in sparse weight matrices or weights masked using a binary mask (depending on the implementation), the computational time taken for inference using standard frameworks will remain the same as that of original network. The current state of standard parallel computing hardware (GPUs) and software (even for CPUs) is not capable of performing fast sparse matrix operations. Structured pruning, on the other hand, involves entire neurons/nodes with all of its incoming and outgoing connections are removed. Even though this puts a certain constraint to the process, it makes the neural network lighter and faster in practical usage.

Since we are more concerned with running the model on the edge devices, we can utilize the structured pruning approach to compress our baseline model. In our case, we can remove channels/filters in the convolutional layers along with its connections to the next and previous layer(s), as shown in FIG. 4. That is, FIG. 4 illustrates a flow diagram depicting logical operational steps of a filter pruning method 40, in accordance with an embodiment.

The method 40 shown in FIG. 4 can be implemented as a very naive way to perform filter pruning. As shown in FIG. 4, features 42 can be subject to filters 44, 46, 48, and 50, with filter 46 shown as a pruning filter, resulting in the pruned features 62. Depending on the target sparsity, we can remove the same percentage of filters from every convolutional layer (e.g., see ‘Cony’ in FIG. 4), except the ‘Detect’ layer which can be a final layer in the YOLOv5 architecture that possesses the same dimensions for output as before. For example, if the target sparsity is 50%, we halve the filters in every convolutional layer. To determine which exact filters to remove, we can calculate the L2 norm of each filter, rank them by their L2 norm and remove the filters having low L2 norm. L2 norm can be calculated as the square root of the sum of squared individual values (x) in the filter i.e., √(Σx²). The intuition is that higher the L2 norm, higher is the weight in the filter, and thus have a higher contribution towards final prediction. Note that after performing pruning, the model needs to be retrained to recover the knowledge it has lost.

Until now, we have described the components of a baseline model or a compressed version of the same. However, one critical issue is to how we can train the model. We can use DNN and training the same requires a huge amount of data, which may not be always available at the beginning. Now consider the scenario where we are deploying the baseline (or a compressed version) model to multiple agents (here vehicles, mounted with cameras & edge devices) and since each of them is involved in capturing videos of roads, can we use the data for each agent to update the parameters of the model? Of course, it should not violate the privacy requirement of the data captured by individual agent. We can address the same here through so-called Federated Learning (FL) paradigm, as described below. We can explore two approaches: Federated Average and Split-Federated learning. In both cases, the setups are similar—we have N clients and a server. The learning happens as each client learns from every other client indirectly through the server.

Note that the term “federated learning” as utilized herein relates to a machine learning technique that trains an algorithm across multiple decentralized edge devices or servers holding local data samples, without exchanging them. This approach stands in contrast to traditional centralized machine learning techniques where all the local datasets are uploaded to one server, as well as to more classical decentralized approaches which often assume that local data samples can identically distributed. Federated learning enables multiple actors to build a common, robust machine learning model without sharing data, thus allowing to address critical issues such as data privacy, data security, data access rights and access to heterogeneous data. Its applications are spread over a number of industries including, for example, defense, telecommunications, Internet-of-things (IoT), and pharmaceutics. A non-limiting example of federated learning is disclosed in U.S. Patent Application Publication No. 20220210140, which published on Jun. 30, 2022, and is incorporated herein by reference in its entirety.

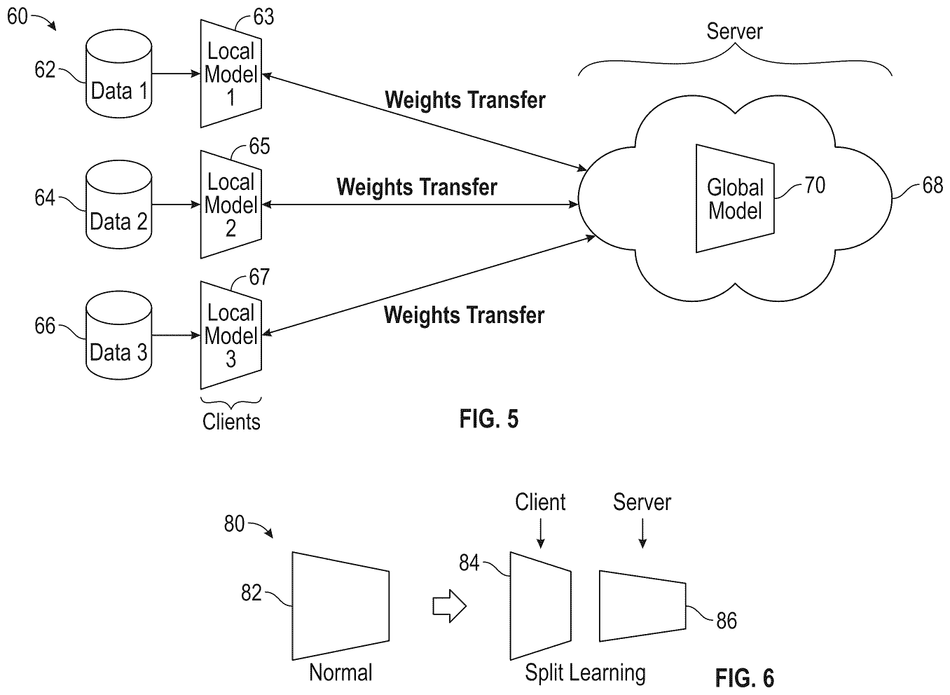

FIG. 5 illustrates a schematic diagram of a federated learning framework 60, which can be implemented in accordance with an embodiment. As shown in FIG. 5, databases 62, 64, 66 can provide data to respectively local models 63, 65, 67, which in turn can be involved in weights transfer with respect to a server 68. Federated Average or FedAvg is a decentralized framework for the training of machine learning models. This model works by having a global model 70 located at the server 68 and N local models 63, 67 located at each of the clients having the same architecture. The server 68 can randomly initialize the global model 70 and sends it to the clients. Each client can train its own copy of the model locally and send the trained local model back to the server 68. All local models can be averaged at the server 68 and the resulting model can be used as the new global model. This is called one global round. A similar process can be repeated for several global rounds until we reach e.g., a specific threshold on our performance metric or maximum number of rounds set at the beginning.

FIG. 6 illustrates a schematic diagram of a split learning framework 80, in accordance with an embodiment. The split learning framework 80 can include a local model 82 that provides data to a client 84, which can communicate with a server 86. Split-Federated learning or SplitFed is a combination of Split learning and Federated learning to place a low computational burden at the client-side. The idea behind split learning is to perform part calculations at the client-side, while the rest of the calculation can be accomplished at the server-side (i.e., server 86 shown in FIG. 6). It does so by splitting a neural network f into two parts f1 and f2 such that, f(x)=f2(f1(x)).

The value f1 generally can include a few initial layers located at the client's end and the remaining layers can be located at the server-side. This can satisfy low compute requirements at the client-side, as well as preserving privacy. One can also split f into three parts if one wants to preserve the privacy of the labels as well. However, split learning cannot train multiple clients in parallel. That is where SplitFed comes in.

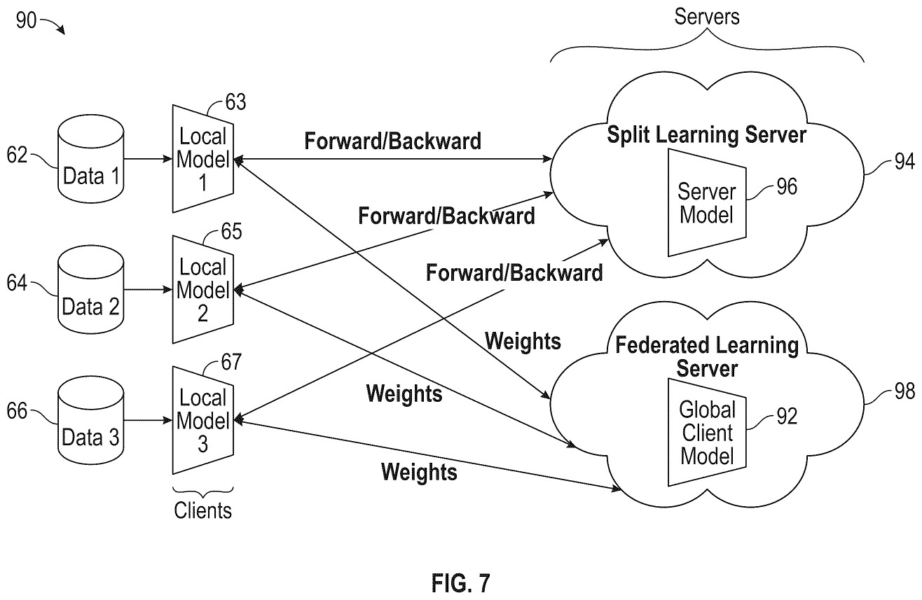

FIG. 7 illustrates a schematic diagram of a split-federated learning framework in accordance with an embodiment. The split-federated (“SplitFed”) learning framework 90 can include one or more databases 62, 64, 66 that can provide data to respective local models 63, 65, 67. The split-federated learning framework 90 can also include a split learning server 94 and a server model 96, along with a federated learning server 98 and a global client model 92.

SplitFed works by making use of the server model 96, the global client model 92, and the N local client models 63, 65, 67. The global client model 92 and the local client model take after f1, whereas the server model takes after f2. For every forward and backward pass, a client needs to communicate with the server. The server can randomly initialize the global client model 92 and send it to the clients. Each client takes forward the inputs through its local model(s), sends activations and labels to the server, the server calculates loss, back propagates until the split layer, updates the server model, sends gradients back to the client, the client calculates loss using that gradient, and finally updates its local model. After several such rounds, the client sends its copy of the trained local model back to the server. All local client models can be averaged at the server and the resulting model can be used as the new global client model.

Embodiments may be implemented as a suite of solutions depending upon the resources of the local edge device (compressed versus uncompressed model) and the type of federation suitable (Centralized/Federated Avg/Split-Federated). We can create a model easily based on any combination of the Federation & compression as suitable for the local edge environment and privacy requirement. The pros and cons of the combinations are outlined in the following table below.

TABLE 1
Suite of solutions (note that the disadvantages are shown in italics)

| Training Model | Centralized | Federated | Split-Federated |
|---|---|---|---|
| Uncompressed | Best performance, | Strong baseline in | Good for clients |
| model | No communication | the federated realm, | w/extremely low |
| (YOLOv5) | required | Less communication | compute, |
| | High compute | required, | More communication |
| | required, | Can do inference | required |
| | Cannot work w/private | w/o the server | Cannot infer w/o the |
| | data | Computationally | server, |
| | | expensive on the | High compute on the |
| | | client as well as the | server side |
| | | server | |
| Compressed | Good performance | Best choice for edge | Good for clients |
| model | w/lighter model, | devices, | w/extremely low |
| (YOLOv5 after | No communication | Lighter model | compute & when |
| pruning) | required | w/slightly lower | lower computational |
| | Cannot work w/private | performance, | burden at the server |
| | data | Can do inference | is needed |
| | | w/o the server | Cannot infer w/o the |
| | | Need to have access | server, |
| | | to some open source | Need to have access |
| | | data for initial | to some open source |
| | | compression | data for initial |
| | | | compression |

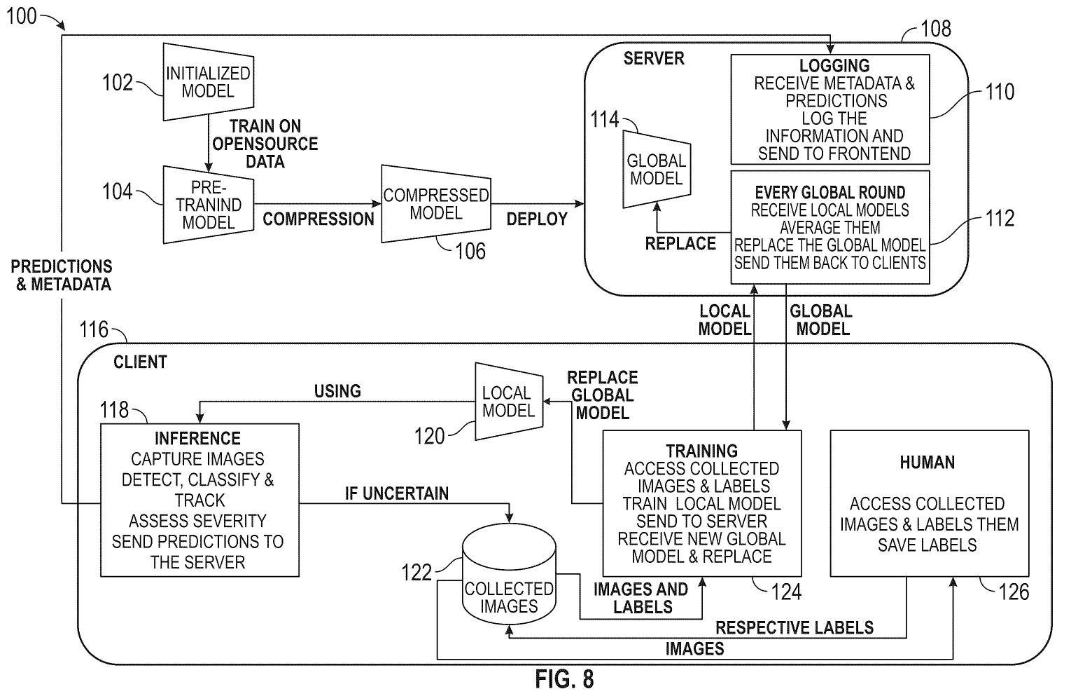

FIG. 8 illustrates a block diagram of a system 100 for infrastructure monitoring, in accordance with an embodiment. The system 100 can include an initialized model 102 and a pre-trained model 104. The initialized model 102 is trained on open source data, which is then provided to the pre-trained model 104. Data output from the pre-trained model 104 can be subject to compression and provided to a compressed model 106. Data output from the compressed model 106 can then be deployed or provided to a server 108.

The server 108 can provide and process, for example, a logging module 110 that implements logging operations such as, for example, receiving metadata and predictions and logging this information and sending it to a front end. The server 108 also perform a global round operation 112 (i.e., every global round) which can involve receiving local models, averaging the local models, and replacing the global model, and sending the global model(s) back to the client(s), such as, for example, a client 116. A global model 114 is shown in FIG. 8 as maintained by the server 108.

The client 116 can include a training module 124 that can implement operations involving, for example, accessing collected images and labels, training a local model, sending information to the server 108, receiving the new global model and implement replace operations. The client 116 also can provide and process an inference module 118, which can involve implement operations involving, for example, the capture of images, along with detection, classifying, tracking, assessing severity, and sending predictions to the server 108. The client 116 also can include a database 122 that stores collected images. The client 116 can further include a local model 120, along with a human component 126 involving accessing collected images and labels and saving this information including saving labels. Note that information related to predications and metadata can be generated as a result of the inference operation 118 and provided to the logging operation 110.

We can initially train YOLOv5 with an object detection & classification model on an open source (road damage) data to classify, for example, data related to road damage. Depending on the computational/memory constraint of a local edge device, an operation can be implemented to compress the model using structure pruning, following by retraining and deployment in the disclosed framework (e.g., see the compressed model 106 deployed to the server 108).

The edge device (e.g. Smartphone, Jetson Nano) with a camera mounted on a vehicle, can capture and store images and metadata (time, location, etc.) as the vehicle is driven through a segment of a road; this data may be private to the agent (vehicle). We can perform object (road damage) detection at the edge on these captured images, and then classify them into various pre-defined categories. These operations can be followed by object tracking using, for example, a SORT (Simple online and real-time tracking) algorithm. Next, we can assess the severity of the damage. Finally, we can send the predictions and metadata to the aforementioned front end (e.g., see the logging operation 110). Subsequently, after deployment further training can be accomplished using a federated learning paradigm—learning continues until we reach, for example, a specific threshold on our performance metric or a maximum number of iterations set at the beginning.

Note that an example of a technology stack that may be utilized to implement an embodiment can include the following:
1. Data engineering and backend: Python tech stack, e.g., pandas, numpy, scipy, scikit-learn, OpenCV, Ultralytics YOLOv5, Classy-SORT, Torch-pruning, TfLite, NNI, Flask
2. Frontend: Python tech stack, e.g., folium,
3. Devops: git, visual studio code, Azure DevOps

In experiments, the number of clients can be three, and the number of local epochs may be five. An example of a data set that can be used to implement an experimental embodiment is the “Road damage detection (RDD) dataset” from the “Global road damage detection” (GRDD) competition. It is open-sourced by Deeksha Arya et al., in their paper titled “Transfer learning based road damage detection for multiple countries,” which is incorporated herein by reference in its entirety.

Note that in some embodiments, we use mAP (mean average precision) as our performance metric whose range is between 0 to 1 and the higher the better. This works by taking the mean of average precision (AP) for different classes, which in turn can be calculated from the precision-recall curve. For all recall values, we observe the precisions and average them.

We can conduct a hypothetical experiment to determine how federated averaging (FedAvg) fares with traditional centralized training on the RDD dataset. Here, we can split the dataset in two parts: 80% for training and 20% for validation purposes. We can fine-tune YOLOv5 pre-trained on MS-COCO in both the cases.

For a centralized approach, we can train on all of the training data at once and validate on the validation data after every epoch. For federated averaging, we can further distribute the training data among 3 clients. After every 5 local epochs on each client, averaging of weights is done to complete a global/communication round, and the global model along with local models are updated. At the end of each global round, i.e., after 5 local epochs, we validate on the same validation data as before. The validation can be done for each client before the averaging and after the averaging (global model).

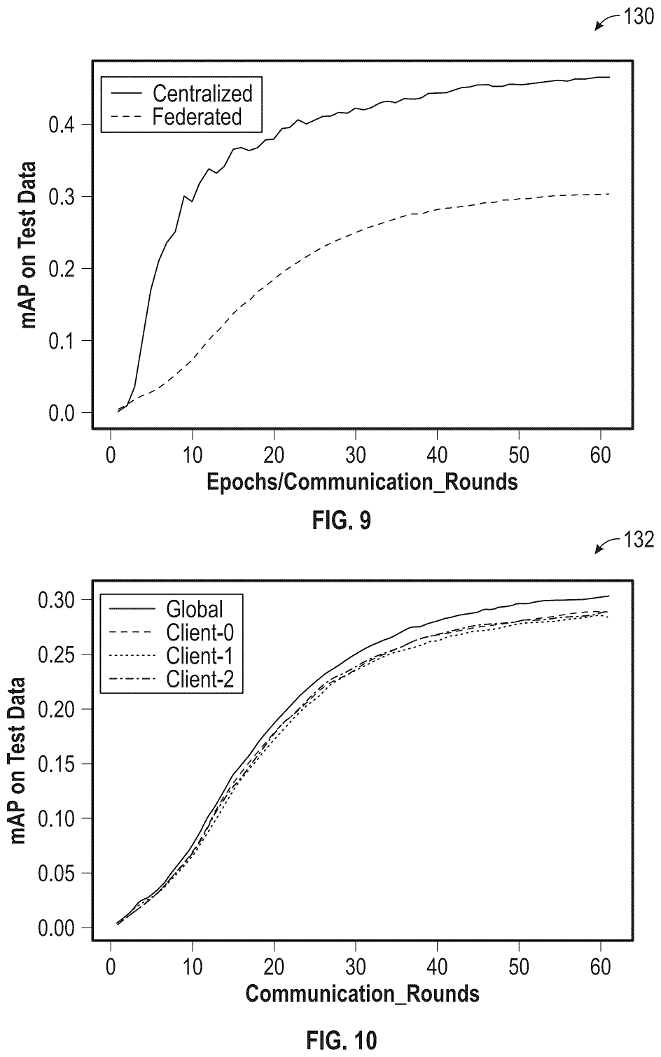

FIG. 9 illustrates an example graph 130 depicting data indicative of centralized learning versus federated learning, in accordance with an embodiment. That is, FIG. 9 demonstrates how the model using centralized training performs compared to the global model in federated learning. The naive federated averaging does not perform exceptionally, but it can be validated, which demonstrates that the federated paradigm works. This is an active area of research and more sophisticated improvements over FedAvg may be developed in time, which can hopefully bridge this gap.

FIG. 10 illustrates an example graph 132 depicting data indicative of a client model versus a global model, in accordance with an embodiment. FIG. 10 compares the performance at the end of each global round just before and after the averaging of weights is done. This can be seen that at every stage, wherein the averaged weights perform slightly better compared to individual weights and thus the training progresses. This adds further proof to our previous statement that federated paradigm works even on complex models such as YOLOv5.

We consider a more practical case of having access to some amount of data that is open-sourced, whereas some amount of data is private. In the first phase, we can train the model on open-source data (e.g., in one experimental case, we took 30% of the training data) via traditional centralized training, then in the second phase, we improve the trained model by further training it using private data (e.g., 70% of the training data) in a federated learning paradigm. Moreover, in the second phase, we can compare various federated learning algorithms against the hypothetical centralized training.

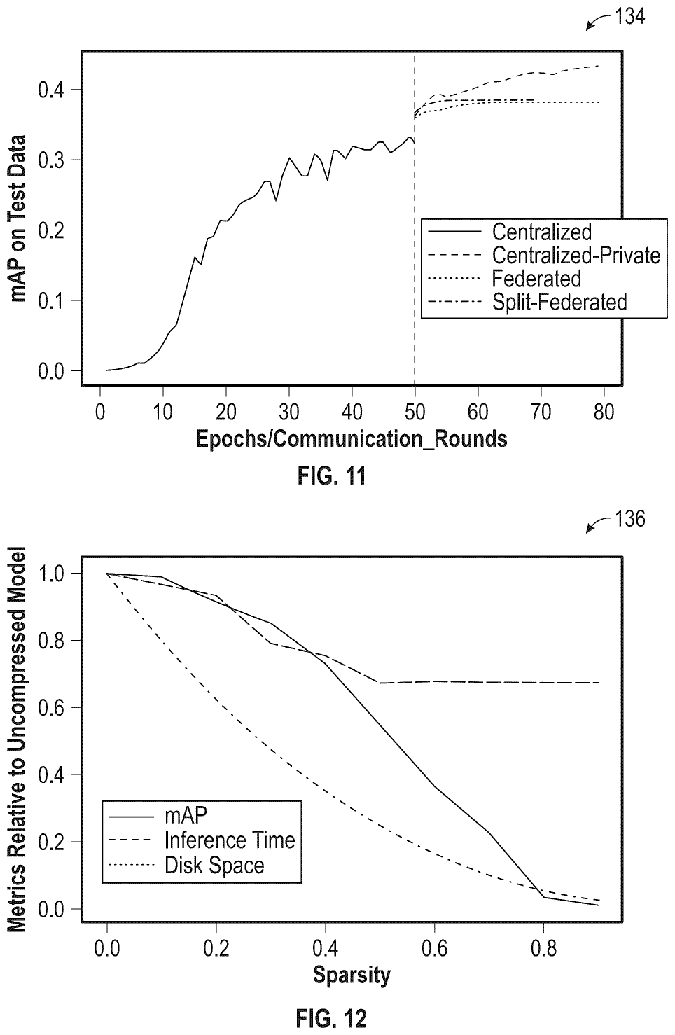

FIG. 11 illustrates an example graph 134 depicting data indicative of training on open-source and then private data, in accordance with an embodiment. FIG. 11 shows training on the open-sourced data of the left side of the vertical (black) line, and training on the private data on the right side. As expected, we can observe that there is a significant increase in performance when additional private data is introduced. Also, in the second phase, the hypothetical centralized training fares better compared to the federated ones. Again, this could be improved by using more sophisticated federated learning algorithms.

FIG. 12 illustrates an example graph 136 depicting data of varying sparsity, in accordance with an embodiment. We can study how pruning affects the already trained model. In FIG. 12, we plot how certain metrics such as performance (mAP), disk space used by the model, and the inference time of the model change as we achieve increasing sparsity levels. Input passed here for calculating inference time has the dimension of (64×3×640×640). The x-axis represents sparsity and y-axis represents the normalized values of each of the metric, 1.0 standing for the uncompressed (sparsity=0.0) model.

For each sparsity level, we can perform one-shot pruning on every convolutional layer (same sparsity for each layer) of the uncompressed model, except those in the Detect layer and then fine-tune for 20 epochs. We see, as the sparsity level increases, all the metrics start to decrease. That is, as less important nodes/filters are removed from the neural network, inference will get faster, and the amount of disk space used by the model will decrease, but at the cost of loss in performance. The important item to note here is that, by only utilizing the naive criteria (L2 norm and every layer) for pruning, the performance curve may be less steep than the disk space and comparable to the inference time curve. There is a great deal of room to improve on the metrics while increasing sparsity level. With more complex methods like pruning layers with variable local sparsity together with AutoML for Model Compression (AMC), we expect the performance curve to become significantly less steep.

The embodiments are described at least in part herein with reference to the flowchart illustrations, steps and/or block diagrams of methods, systems, and computer program products and data structures and scripts. It will be understood that each block of the illustrations, and combinations of blocks, can be implemented by computer program instructions. These computer program instructions may be provided to a processor of, for example, a general-purpose computer, special-purpose computer, or other programmable data processing apparatus to produce a machine, such that the instructions, which can execute via the processor of the computer or other programmable data processing apparatus and may create means for implementing the functions/acts specified in the block or blocks.

To be clear, the disclosed embodiments can be implemented in some cases in the context of, for example a special-purpose computer or a general-purpose computer, or other programmable data processing apparatus or system. For example, in some example embodiments, a data processing apparatus or system can be implemented as a combination of a special-purpose computer and a general-purpose computer. In this regard, a system composed of different hardware and software modules and different types of features may be considered a special-purpose computer designed with a purpose of image processing images captured by an image-capturing device, such as discussed herein. In general, however, embodiments may be implemented as a method, and/or a computer program product at any possible technical detail level of integration. The computer program product may include a computer readable storage medium (or media) having computer readable program instructions thereon for causing a processor to carry out aspects of the embodiments, such as the steps, operations or instructions described herein.

The aforementioned computer program instructions may also be stored in a computer-readable memory that can direct a computer or other programmable data processing apparatus to function in a particular manner, such that the instructions (e.g., steps/operations) stored in the computer-readable memory produce an article of manufacture including instruction means, which can implement the function/act specified in the various block or blocks, flowcharts, and other architecture illustrated and described herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks herein.

The flow charts and block diagrams in the figure can illustrate the architecture, the functionality, and the operation of possible implementations of systems, methods, and computer program products according to various embodiments (e.g., preferred or alternative embodiments). In this regard, each block in the flow chart or block diagrams may represent a module, a segment, or a portion of instructions, which comprises one or more executable instructions for implementing the specified logical function(s).

In some alternative implementations, the functions noted in the blocks may occur out of the order noted in the figures. For example, two blocks shown in succession may, in fact, be executed concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The functionalities described herein may be implemented entirely and non-abstractly as physical hardware, entirely as physical non-abstract software (including firmware, resident software, micro-code, etc.) or combining non-abstract software and hardware implementations that may all generally be referred to herein as a “circuit,” “module,” “engine”, “component,” “block”, “database”, “agent” or “system.” Furthermore, aspects of the present disclosure may take the form of a computer program product embodied in one or more non-ephemeral computer readable media having computer readable and/or executable program code embodied thereon.

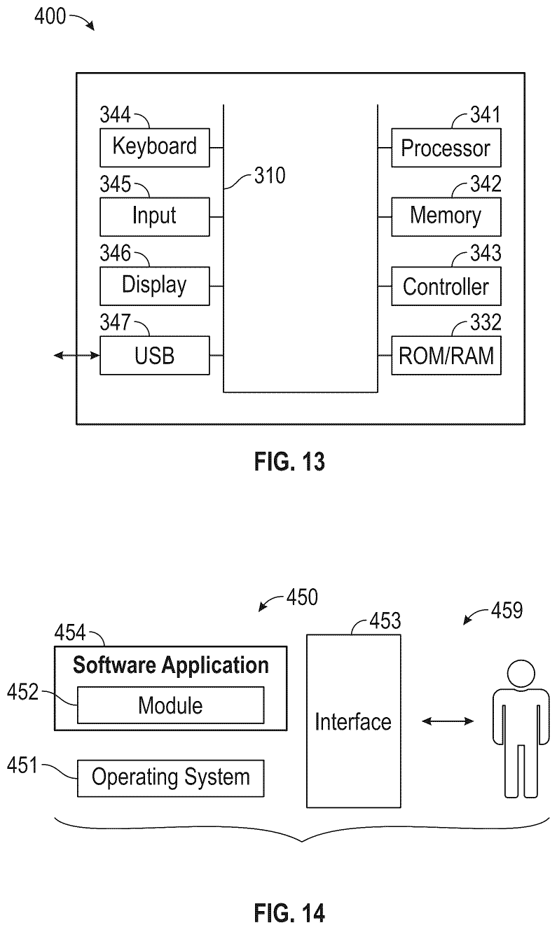

FIG. 13 and FIG. 14 are shown only as exemplary diagrams of data-processing environments in which example embodiments may be implemented. It should be appreciated that FIG. 13 and FIG. 14 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 13, some embodiments may be implemented in the context of a data-processing system 400 that can include, for example, one or more processors such as a processor 341 (e.g., a CPU (Central Processing Unit) and/or other microprocessors), a memory 342, a controller 343, additional memory such as ROM/RAM 332 (i.e. ROM and/or RAM), a peripheral USB (Universal Serial Bus) connection 347, a keyboard 344 and/or another input device 345 (e.g., a pointing device, such as a mouse, track ball, pen device, etc.), a display 346 (e.g., a monitor, touch screen display, etc.) and/or other peripheral connections and components.

A system bus 310 can serve as a main electronic information highway interconnecting the other illustrated components of the hardware of data-processing system 400. The system bus 310 can function as a communication system that transfers data between components inside the data-processing system 400 (e.g., a computer), or between computers. The system bus 310 can include all related hardware components (e.g., wire, optical fiber, etc.) and software, including communication protocols.

In some embodiments, the processor 341 may be a CPU that functions as the central processing unit of the data-processing system 400, performing calculations and logic operations required to execute a program. Read only memory (ROM) and random access memory (RAM) of the ROM/RAM 344 constitute examples of non-transitory computer-readable storage media.

The controller 343 can interface with one or more optional non-transitory computer-readable storage media to the system bus 310. These storage media may include, for example, an external or internal DVD drive, a CD ROM drive, a hard drive, flash memory, a USB drive or the like. These various drives and controllers can be optional devices. Program instructions, software or interactive modules for providing an interface and performing any querying or analysis associated with one or more data sets may be stored in, for example, ROM and/or RAM 344. Optionally, the program instructions may be stored on a tangible, non-transitory computer-readable medium such as a compact disk, a digital disk, flash memory, a memory card, a USB drive, an optical disc storage medium and/or other recording medium.

As illustrated, the various components of data-processing system 400 can communicate electronically through a system bus 310 or similar architecture. The system bus 310 may be, for example, a subsystem that transfers data between, for example, computer components within data-processing system 400 or to and from other data-processing devices, components, computers, etc. The data-processing system 400 may be implemented in some embodiments as, for example, a server in a client-server based network (e.g., the Internet) or in the context of a client and a server (i.e., where aspects are practiced on the client and the server).

In some example embodiments, data-processing system 400 may be, for example, a standalone desktop computer, a laptop computer, a Smartphone, a pad computing device and so on, wherein each such device is operably connected to and/or in communication with a client-server based network or other types of networks (e.g., cellular networks, Wi-Fi, etc.).

FIG. 14 illustrates a computer software system 450 for directing the operation of the data-processing system 400 depicted in FIG. 13. The software application 454, may be stored for example in memory 342 and/or another memory and can include one or more modules such as the module 452. The computer software system 450 also includes a kernel or operating system 451 and a shell or interface 453. One or more application programs, such as software application 454, may be “loaded” (i.e., transferred from, for example, mass storage or another memory location into the memory 342) for execution by the data-processing system 400. The data-processing system 400 can receive user commands and data through the interface 453; these inputs may then be acted upon by the data-processing system 400 in accordance with instructions from operating system 451 and/or software application 454. The interface 453 in some embodiments can serve to display results, whereupon a user 459 may supply additional inputs or terminate a session. The software application 454 can include module(s) 452, which can, for example, implement the steps, instructions, operations and algorithms such as those discussed herein. For example, the module 452 can implement the steps, operations and instructions illustrated and described herein with respect to the various blocks shown in the figures herein.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” (also referred to as an “engine”) may constitute a software application but can also be implemented as both software and hardware (i.e., a combination of software and hardware).

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein can refer to a collection of routines and data structures, which can perform a particular task or can implement a particular data type. A module can be composed of two parts: an interface, which lists the constants, data types, variable, and routines that can be accessed by other modules or routines, and an implementation, which is typically private (accessible only to that module) and which includes source code that actually implements the routines in the module. The term module as utilized may also simply refer to an application, such as a computer program designed to assist in the performance of a specific task, such as word processing, accounting, inventory management, etc.

In some example embodiments, the term “module” can also refer to a modular hardware component or a component that is a combination of hardware and software. It should be appreciated that implementation and processing of the disclosed modules, whether primarily software-based and/or hardware-based or a combination thereof, according to the approach described herein can lead to improvements in processing speed and ultimately in energy savings and efficiencies in a data-processing system such as, for example, the data-processing system 400 shown in FIG. 13.

Other examples of ‘modules’ as utilized herein can include, for example, the various models and operations illustrated and described herein with respect to FIG. 8. For example, FIG. 8 includes a training module 124, an inference module 118, a logging module 110, and so on. The initialized model 102 and pre-trained model 106 shown in FIG. 8 may be implemented as modules that provide for such models. Similarly, the global model 114 and the compressed model 106 shown in FIG. 8 may be implemented as a module.

The disclosed embodiments can constitute an improvement to a computer system (e.g., such as the data-processing system 400 shown in FIG. 13 rather than simply the use of the computer system as a tool. The disclosed modules, instructions, steps and functionalities discussed herein can result in a specific improvement over prior systems, resulting in improved data-processing systems.

FIG. 13 and FIG. 14 are intended as examples and not as architectural limitations of disclosed embodiments. Additionally, such embodiments are not limited to any particular application or computing or data processing environment. Instead, those skilled in the art will appreciate that the disclosed approach may be advantageously applied to a variety of systems and application software. Moreover, the disclosed embodiments can be embodied on a variety of different computing platforms, including Macintosh, UNIX, LINUX, and the like.

It is understood that the specific order or hierarchy of steps, operations, or instructions in the processes or methods disclosed is an illustration of exemplary approaches. For example, the various steps, operations or instructions discussed herein can be performed in a different order. Similarly, the various steps and operations of the disclosed example pseudo-code discussed herein can be varied and processed in a different order. Based upon design preferences, it is understood that the specific order or hierarchy of such steps, operation or instructions in the processes or methods discussed and illustrated herein may be rearranged. The accompanying claims, for example, present elements of the various steps, operations or instructions in a sample order, and are not meant to be limited to the specific order or hierarchy presented.

Based on the foregoing, it can be appreciated that a number of embodiments are disclosed. For example, in an embodiment a method of monitoring infrastructure, can involve: capturing video of infrastructure; and generating an inference of damage to the infrastructure and a severity thereof based on images in the captured video and in response to running the inference locally on at least one edge device.

In an embodiment, the running of the inference locally on the at least one edge device can involve using a compression of models to run the inference on the at least one edge device with a low computational resource.

In an embodiment, privacy preserved learning can be enabled when generating the inference and the severity thereof by using distributed data subject to at least one federated learning framework.

In an embodiment, the at least one edge device can include a camera mounted on at least one vehicle of a public transportation fleet of vehicles.

An embodiment can also involve capturing the location of the damage based on a position of the at least one vehicle.

An embodiment can further involve displaying data indicative of the inference of damage to the infrastructure in a cartographic display.

An embodiment can also involve distributing training data among a plurality of clients, the training data utilized in generating the interference of damage.

In an embodiment, system for monitoring infrastructure, can include: at least one image-capturing device for capturing video of infrastructure; and at least one edge device that communicates with the at least one image-capturing device, wherein an inference of damage to the infrastructure and a severity thereof based on images in the captured video are generated in response to running the inference locally on the at least one edge device.

In an embodiment, a system of monitoring infrastructure, can include at least one processor and a memory, the memory storing instructions to cause the at least one processor to perform: capturing video of infrastructure; and generating an inference of damage to the infrastructure and a severity thereof based on images in the captured video and in response to running the inference locally on at least one edge device.

The methods, systems and devices as described and claimed herein are non-abstract. No description has been offered of any abstract implementations. Accordingly, the claims are to be construed as covering only non-abstract subject matter. Any person who construed them otherwise would be construing them incorrectly and without regard to the specification.

Applicant and/or the inventors, acting as their own lexicographer, hereby defines “non-abstract” as the complement of “abstract” as that term has been defined by the courts of the United States as of the filing date of this application.

The methods and systems as described herein also have a technical effect. In many cases, the technical effect will be non-obvious. However, it exists. Therefore, any person who construes the claims as lacking a technical effect is merely displaying an inability to discern the technical effect as a result of its non-obviousness.

The processing system or device (e.g., ‘processor(s)) that executes the method is not a generic computer. It is a specialized digital electronic device that can be specially adapted for operation to accommodate the various technical constraints imposed by a “Smart City” environment including the inability to adequately identify and repair damaged infrastructure in this type of environment.

Additionally, though it is convenient to implement the method using software instructions, it is known that virtually any set of software instructions can be implemented by specially designed hardware, which is typically provided as an application-specific integrated circuit. The claims presented herein are also intended to cover such an implementation.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A method of monitoring infrastructure, comprising:
capturing video of infrastructure; and
generating an inference of damage to the infrastructure and a severity thereof based on images in the captured video and in response to running the inference locally on at least one edge device.

2. The method of claim 1 wherein the running of the inference locally on the at least one edge device comprises using a compression of models to run the inference on the at least one edge device with a low computational resource.

3. The method of claim 1 enabling privacy preserved learning when generating the inference and the severity thereof by using distributed data subject to at least one federated learning framework.

4. The method of claim 1 wherein the at least one edge device includes a camera mounted on at least one vehicle of a public transportation fleet of vehicles.

5. The method of claim 4 further comprising capturing the location of the damage based on a position of the at least one vehicle.

6. The method of claim 1 further comprising displaying data indicative of the inference of damage to the infrastructure in a cartographic display.

7. The method of claim 1 further comprising: distributing training data among a plurality of clients, wherein the training data utilized in generating the inference of damage.

8. A system for monitoring infrastructure, comprising:
at least one image-capturing device for capturing video of infrastructure; and
at least one edge device that communicates with the at least one image-capturing device, wherein an inference of damage to the infrastructure and a severity thereof based on images in the captured video are generated in response to running the inference locally on the at least one edge device.

9. The system of claim 8 wherein the running of the inference locally on the at least one edge device comprises using a compression of models to run the inference on the at least one edge device with a low computational resource.

10. The system of claim 8 wherein privacy preserved learning is enabled when generating the inference and the severity thereof by using distributed data subject to at least one federated learning framework.

11. The system of claim 8 wherein the at least one edge device is associated with the at least one image-capturing device mounted on at least one vehicle of a public transportation fleet of vehicles.

12. The system of claim 11 further wherein the location of the damage is captured by the at least one image-capturing device based on a position of the at least one vehicle.

13. The system of claim 8 further comprising a cartographic display for displaying data indicative of the inference of damage to the infrastructure.

14. The system of claim 8 wherein training data is distributed among a plurality of clients, the training data utilized in generating the inference of damage.

15. A system of monitoring infrastructure, comprising:
at least one processor and a memory, the memory storing instructions to cause the at least one processor to perform:
capturing video of infrastructure; and
generating an inference of damage to the infrastructure and a severity thereof based on images in the captured video and in response to running the inference locally on at least one edge device.

16. The system of claim 14 wherein the instructions are further configured to cause the at least one processor to perform: running of the inference locally on the at least one edge device comprises using a compression of models to run the inference on the at least one edge device with a low computational resource.

17. The system of claim 14 wherein the instructions are further configured to cause the at least one processor to perform: enabling privacy preserved learning when generating the inference and the severity thereof by using distributed data subject to at least one federated learning framework.

18. The system of claim 14 wherein the at least one edge device includes a camera mounted on at least one vehicle of a public transportation fleet of vehicles.

19. The system of claim 18 wherein the instructions are further configured to cause the at least one processor to perform: capturing the location of the damage based on a position of the at least one vehicle.

20. The system of claim 14 wherein the instructions are further configured to cause the at least one processor to perform: displaying data indicative of the inference of damage to the infrastructure in a cartographic display.
